(19) United States
(12) Patent Application Publication
(10) Pub. No.: US 2007/0127481 A1
(43) Pub. Date: Jun. 7, 2007

(54) Streaming service providing method and apparatus for P2P based network

(76) Inventors: Yoo Hyun Park, Daejeon (KR); Chang Soo Kim, Daejeon (KR); Sang Min Woo, Daegu (KR); Won Jae Lee, Daejeon (KR); Ok Gi Min, Daejeon (KR); Hag Young Kim, Daejeon (KR)

Correspondence Address: LADAS & PARRY LLP, 224 SOUTH MICHIGAN AVENUE, SUITE 1600, CHICAGO, IL, 60604, US

(21) Appl. No.: 11/523,106

(22) Filed: Sep. 19, 2006

(30) Foreign Application Priority Data
Dec. 6, 2005 (KR) 10-2005-0118219

(51) Int. Cl. H04L 12/56

(52) U.S. Cl. 370/392; 370/401

(57) ABSTRACT

A method and apparatus for providing a peer-to-peer (P2P) based streaming service are provided. The method provides a streaming service in a peer-to-peer (P2P) network comprising a plurality of peers. That is, a receiving peer requests a plurality of transmitting peers having contents for a streaming service among peers in the P2P network to transmit the contents. Then, the receiving peer receives identical portions of the same content from the plurality of transmitting peers at the same time. After receiving, the receiving peer provides a streaming service for the received content from a first transmitting peer among the plurality of transmitting peers to a user.

### RELATED APPLICATION

The present application is based on, and claims priority from, Korean Application Number 2005-0118219, filed Dec. 6, 2005, the disclosure of which is hereby incorporated by reference herein in its entirety.

### BACKGROUND OF THE INVENTION

1. Field of the Invention

The present invention relates to a method and apparatus for providing a peer-to-peer (P2P) based streaming service, and more particularly, to a method and apparatus for providing a multimedia streaming service using a peer-to-peer (P2P) data transmit scheme in order to provide a stable streaming service in a P2P network comprising a plurality of peer nodes.

2. Description of the Related Art

Streaming denotes a technology for optimally using network and CPU resources by transmitting, receiving and decoding large multimedia data such as video and audio data in real time. That is, the streaming is a technology for continually processing transmitting data without interruption as like as the flow of water. The streaming technology has received more attention with the growth of the Internet because most of users do not have an access line that supports a download rate fast enough to download large multimedia instantly.

A conventional method requires a receiving side to download an entire content to receive a service, so users must wait such a long time for downloading the entire contents. However, the streaming technology allows a client's browser or a plug-in program to reproduce data before downloading entire contents. As described above, the streaming technology has an advantage that enables a user to instantly receive a desired service as soon as the user selects contents.

In a peer-to-peer (P2P) structure, a peer has a limitation to simultaneously provide services because many peers in the P2P based network having less computing power than a server. Also, the streaming service is restrictive because peers can leave a corresponding P2P network without any restrictions.

Although the streaming service in the P2P based network have shortcomings, many technologies related to the P2P based streaming service have been introduced because specifications of personal computers (PC) have been enhanced. As a conventional streaming technology, a method for providing multimedia streaming service by using point-to-point connection was introduced in Korea Patent Publication 2003-56701. After a client receives data from a server, the client functions as a temporal server in a corresponding client group to provide the streaming service of the received multimedia data. However, the conventional method requires a server's help to transmit data, and the client that functions as a temporal server still has limitation to simultaneously provide a streaming service.

Another conventional content distribution method was introduced in an article by Sung-Yong Lee et al., entitled “Multi-Source Media Streaming based Contents Distribution in P2P Network Environment Authors” Korea Information Processing Society Journal No. 5 11-A, October 2004. In the conventional distribution method, a content to transmit is divided into a plurality of regions, and a predetermined region of the content is transmitted under the charge of a predetermined peer. In order to increase a speed of fetching a content, the conventional distribution method provides a service by dividing a content equally and receiving each of the divided portions of the content from different peers. Although the conventional distribution method increases a transmit rate, the conventional distribution method has a problem of interrupting the streaming service if a peer that manages to transmit a content in a current transmitting region leaves a network or a content transmit rate of the peer is abruptly reduced.

### SUMMARY OF THE INVENTION

The present invention provides a streaming service providing method and apparatus for a P2P based network that substantially obviates one or more problems due to limitations and disadvantages of the related art.

An object of the present invention is to provide a P2P based streaming service providing method for stably providing a streaming service on a P2P network where peers have a high probability of leaving a network and the network states of peers dynamically change.

Another object of the present invention is to provide a P2P based streaming service providing method for providing a streaming service by enabling a predetermined peer that provides a streaming service to receive the identical portion of same content from a plurality of source peers at the same time.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

To achieve these objects and other advantages and in accordance with the purpose of the invention, as embodied and broadly described herein, a method for providing a streaming service in a peer-to-peer (P2P) network comprising a plurality of peers, the method including the steps of: a) at a receiving peer, requesting a plurality of transmitting peers having contents for a streaming service among peers in the P2P network to transmit the contents; b) receiving identical portions of the same content from the plurality of transmitting peers at the same time; and c) providing a streaming service for the received content from a first transmitting peer among the plurality of transmitting peers to a user.

The step a) may include the step of searching other peers having the content for the streaming service among peers in the P2P network.

The step b) may include the step of storing the identical contents received from the plurality of transmitting peers into different receiving buffers.

The transmitting peer may be selected from the plurality of peers transmitting the contents based on a content transmit rate.

A peer having a fastest content transmit rate may be decided as the first transmitting peer.

In the step c), the streaming service of the content may be provided to a user in real time at the same time of receiving the content from the first transmitting peer.

The step c) may include the step of storing the content at a predetermined storing unit at the same time of providing the streaming service of the content received from the first transmitting peer.

The step c) may further include the step of storing content received from a second transmitting peer among the plurality of transmitting peers in a predetermined storing unit.

The step c) may further include the step of continuously providing a streaming service of a content using an identical content received from the second transmitting peer among the plurality of transmitting peers when the receiving of the content from the first transmitting peer is interrupted or the transmit rate of the first transmitting peer abruptly decreases, and storing the content in a predetermined storing unit at the same time.

The step c) may further include the step of continuously providing a streaming service of a content using an identical content received from the second transmitting peer among the plurality of transmitting peers when the receiving of the content from the first transmitting peer is interrupted or the transmit rate of the first transmitting peer is abruptly decreased, receiving an identical content from a third transmitting peer and storing the contents in a predetermined storing unit at the same time.

According to an aspect of the present invention, there is provided an apparatus for providing a P2P based streaming service through a P2P network comprising a plurality of peers, the apparatus including: a content transmitting unit including a streaming transmitting daemon for performing a program for providing a P2P based streaming service through a P2P network comprising a plurality of peers, and a transmitting buffer for temporally storing contents to transmit to each peer; a peer searching unit for searching peers that have a content to provide a streaming service among the plurality of peers in the P2P network; and a content receiving unit includes a streaming receiving daemon for performing a program for receiving a streaming service through the P2P network, a receiving buffer unit having a plurality of receiving buffers for storing identical contents transmitted from different peers through the P2P network, a streaming service unit for providing a streaming service for a content received from one of the different transmitting peers, a transmission error detecting unit for checking at least one of information about whether a peer that transmits a content leaves or not, a content transmit rate and a delay of a streaming service speed, and a storing process unit for storing the contents transmitted from the different peers into a predetermined storing unit.

One having the fastest content transmit rate among the plurality of different peers may be decided as the transmitting peer.

The content receiving unit may continuously provide a streaming service using identical contents received from other peers when the receipt of the content from the transmit peer is interrupted or the transmit rate of the transmitting peer abruptly decreases.

The content receiving unit may provide the streaming service for the content to a user at the same time of receiving the content from the predetermined peer.

It is to be understood that both the foregoing general description and the following detailed description of the present invention are exemplary and explanatory and are intended to provide further explanation of the invention as claimed.

The present invention relates to a method and apparatus for providing a multimedia streaming service in a P2P based network. Particularly, the present invention relates a method and apparatus for providing a multimedia streaming service using a peer-to-peer (P2P) data transmit scheme in order to provide a stable streaming service in a P2P network comprising a plurality of peer nodes.

A predetermined peer for providing a streaming service searches a plurality of peers having a target content for a streaming service, and receives the target contents from the searched peers at the same time so as to provide the streaming service. Although a peer that provides the content leaves the P2P network or the content transmit rate of the peer abruptly decreases while the predetermined peer is receiving the identical contents, the predetermined peer continuously provides the streaming service using contents received from other peers. Also, the predetermined peers receive the identical content by searching other peers. Therefore, the streaming service can be stably provided to a user in the P2P network.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings:

FIG. 1 is a view of a P2P network where a present invention is applied;

FIG. 2 is a view for describing providing of contents in a method for providing a P2P based streaming service according to an embodiment of the present invention;

FIG. 3 is a view for describing providing of a streaming service in a method for providing a P2P based streaming service according to an embodiment of the present invention; and

FIG. 4 is a block diagram illustrating an apparatus for providing a P2P based streaming service according to an embodiment of the present invention

### DETAILED DESCRIPTION OF THE INVENTION

Reference will now be made in detail to the preferred embodiments of the present invention, examples of which are illustrated in the accompanying drawings.

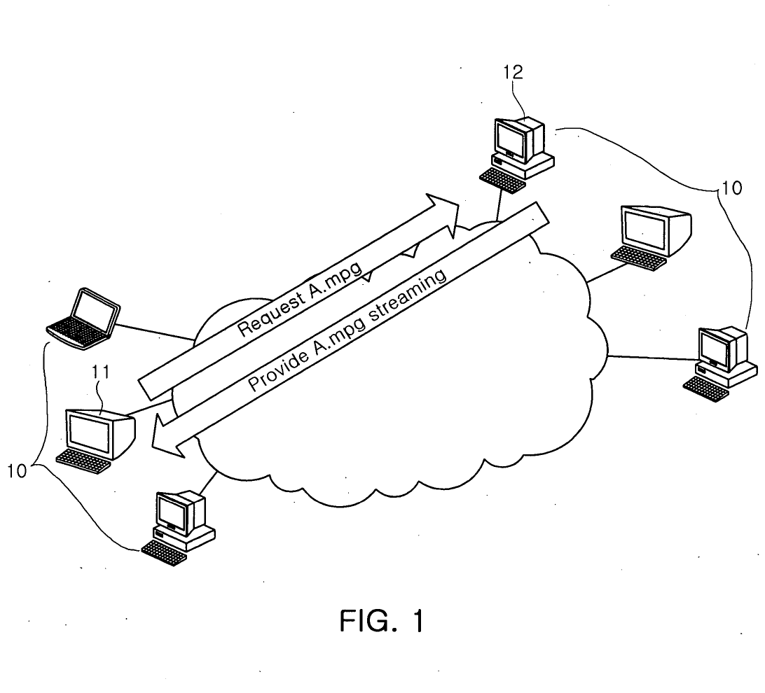

FIG. 1 is a view of a P2P network where a present invention is applied.

As shown in FIG. 1, in the P2P network, various types of computers 10 are connected through a network 20. Hereinafter, the computers 10 are referred to as peers. Each of the peers 10 shares own contents with other peers through the network 20. Especially, if a first peer wants a predetermined content stored in a second peer and fetches the predetermined content from the second peer, the second peer functions as a server, and the first peer functions as a client.

In FIG. 1, in order to provide a streaming service on the P2P network, peers having a desired content are searched, and the searched peers are requested to transmit the desired content. Then, the requested peers transmit the corresponding content as the response of the request. For example, it assumes that a first peer 11 has contents, B.mpg, and C.mpg, and a second peer 12 has contents, A.mpg, B.mpg, and C.mpg. Under the assumption, if the first peer 11 wants to receive a streaming service for A.mpg, the first peer 11 requests the streaming service for A.mpg to the second peer 12. Then, the second peer 12 transmits the steaming service for A.mpg to the first peer 11 as the response of the request.

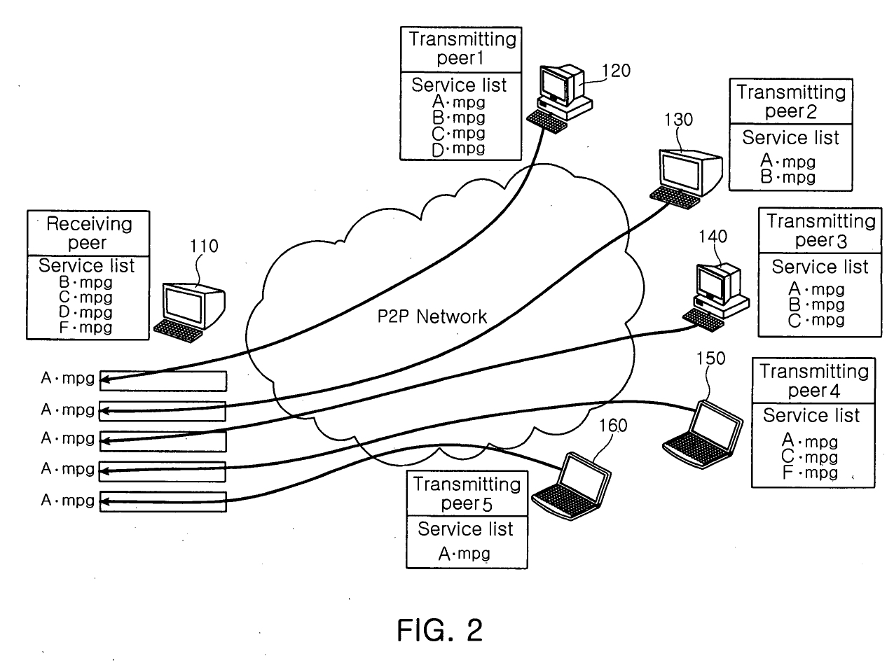

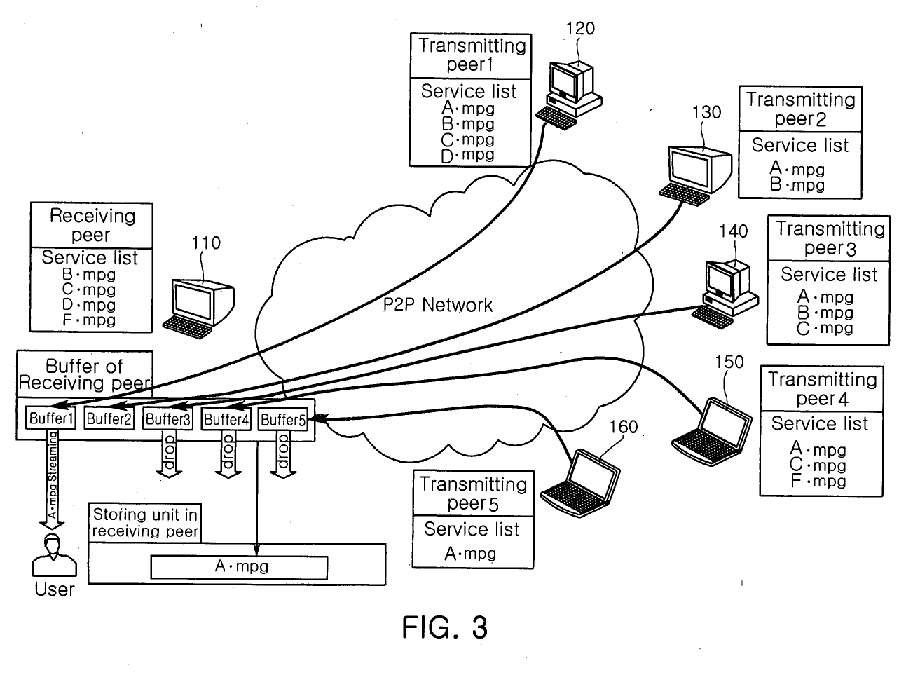

FIGS. 2 and 3 are views for describing a method for providing a P2P based streaming service according to an embodiment of the present invention.

Referring to FIG. 2, a plurality of peers are connected one another through a network. Among the peers, a peer that provides streaming services by receiving contents is called a receiving peer 110, and peers that transmit contents to the receiving peer 110 are called transmitting peers 120 to 150.

As shown in FIG. 2, a receiving peer 110 searches other peers in the P2P network to find transmitting peers 120 to 150 that include a target content, A.mpg. Then, the receiving peer 110 requests the streaming service for the target content, A.mpg, to the found transmitting peers 120 to 150. The transmitting peers 120 to 150 having the identical target content, A.mpg, simultaneously transmit the identical portion of the same content, A.mpg, to the receiving peer 110. As described above, the transmitting peers 120 to 150 transmit the identical portion of the same content to the receiving peer at the same time unlikely to a conventional method that divides the content equally and controls transmitting peers to transmit corresponding divided portions. It is because jitter may occur when one of the transmitting peers that transmits a corresponding divided potion may leave the P2P network or the transmit rate of the transmitting peer abruptly decreases. The jitter denotes the interruption of streaming service.

Also, if a content is received from one predetermined peer in a P2P network where peers frequently leave the P2P network and where the network condition thereof dynamically changes, jitter occurs when the predetermined peer leaves the P2P network and the content transmit rate thereof abruptly decrease.

Therefore, the receiving peer receives the identical portions of the same content from a plurality of transmitting peers at the same time, and selects one of the transmitting peers to provide the streaming service to a user. After receiving, the receiving peer stores the identical portions of the same content received from the unselected transmitting peers at a predetermined storage device such as a disk or deletes them immediately.

Hereinafter, a method for providing a P2P based streaming service according to an embodiment of the present invention will be described with reference to FIG. 3.

As described above, the receiving peer 110 receives the identical portions of the same content, A.mpg, from a plurality of transmitting peers 120 to 150 at the same time and stores the received content, A.mpg, in a plurality of receiving buffers. For example, the receiving peer 110 stores A.mpg received from the first transmitting peer 120 into a first receiving buffer, stores A.mpg received from the second transmitting peer 120 in a second receiving buffer, and stores A.mpg received from the third transmitting peer 130 in a third receiving buffer. As described above, the receiving peer 110 receives the identical portions of the same content, A.mpg, from the transmitting peers at the same time and stores them in different receiving buffers. At the same time, the receiving peer 110 provides a stream service for the content, A.mpg, by selecting one of the receiving buffers. Herein, it is preferable that the receiving peer 110 may select one that receives the content in the shortest time or one that has the fastest transmit rate among the receiving buffers.

In a case of providing a streaming service to a user using the content A.mpg received from the first transmitting peer 120, the content A.mpg received from the second transmitting peer 130 may be stored in a predetermined storage device, and the contents A.mpg received from the third and fourth transmitting peers 140 and 150 are deleted. Herein, the first, second and third transmitting peers are selected according to the content transmit rate. For example, a peer having the fastest content transmit rate is decided as the first transmitting peer 120, a peer having the second fastest content transmit rate is decided as the second transmitting peer 130, and peers having the third and fourth fastest content transmit rate are decided as the third and the fourth transmitting peers 140 and 150.

If the first transmitting peer 120 leaves the P2P network or the content transmit rate of the first transmitting peer 120 is abruptly decreased while the receiving peer receives the content A.mpg from the first transmitting peer 120, the receiving peer 110 instantly selects one of other transmitting peers, for example, the second transmitting peer 130, and provides a streaming service using the content A.mpg transmitted from the newly selected one. If the receiving peer needs more new transmitting peers, the receiving peer searches the new peers and selects one of the newly searched peers. Then, the newly selected peer transmits the remained portion of the content A.mpg based on the current streaming service providing information of the content A.mpg, which is stored in the receiving peer 110.

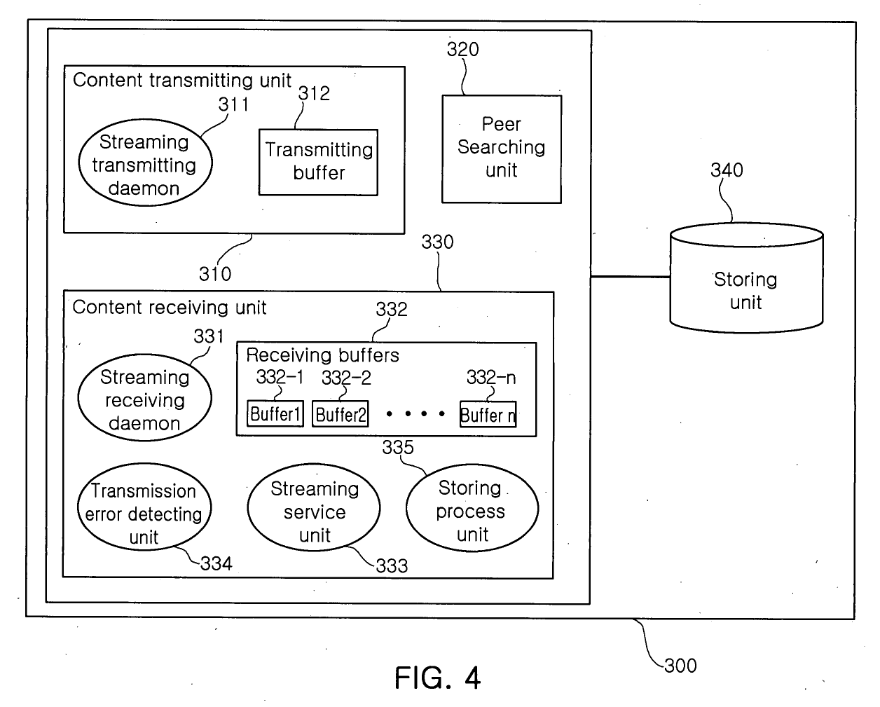

FIG. 4 is a block diagram illustrating an apparatus for providing a P2P based streaming service according to an embodiment of the present invention.

Referring to FIG. 4, the P2P based streaming service providing apparatus 300 according to the present embodiment includes a content transmitting unit 310, a peer searching unit 320 and a content receiving unit 330. The content transmitting unit 310 performs a function of transmitting content on the P2P network. The peer searching unit 320 searches peers, that can provide contents requested from a receiving peer, among peers in the P2P network. The content receiving unit 330 provides a streaming service for the content to a user by receiving the contents from the other peers. Furthermore, the P2P based streaming service providing apparatus 300 may further include a storing unit 340 for storing contents transmitted or received at the P2P streaming service providing apparatus 300. It is preferable that a hard disk may be used as the storing unit 340.

The content transmitting unit 310 includes a streaming transmitting daemon 311 and a transmitting buffer 312. The streaming transmitting daemon 311 is a program for performing a streaming service through the P2P network. The streaming transmitting daemon requests a streaming service to peers in the P2P network and processes related data. Also, the streaming transmitting daemon 312 temporally stores the content to transmit to other peers.

The peer searching unit 320 searches transmitting peers that can provide contents for a receiving streaming service. For example, the peer searching unit 320 decides one transmitting peer having the fastest service speed or the fastest transmit rate as a main transmitting peer, or decides a plurality of other transmitting peers as secondary transmitting peers for receiving continuously receiving the contents when the main transmitting peer leaves the P2P network or the transmit rate thereof abruptly decreases. The receiving peer receives the content from one of the main transmitting peer or the secondary transmitting peers.

The content receiving unit 330 includes a streaming receiving daemon 331, a receiving buffer unit 332, a streaming service unit 333, a transmission error detecting unit 334 and a storing process unit 335. The streaming receiving daemon 331 is a program executed for providing a streaming service in correspondent to the streaming transmitting daemon 311. The streaming receiving daemon 331 performs operations for receiving the streaming service from the peers in the P2P network and processing related data. The streaming receiving daemon 331 includes n receiving buffers 332-1 to 332-n where n denotes an integer number larger than 2. The receiving buffers 332-1 to 332-n store the contents received from corresponding peers through the streaming service in a 1:1 manner. Therefore, the content received from one peer through the related streaming service is stored in one receiving buffer.

The streaming service unit 333 provides a streaming service to a user for the content stored in the receiving buffer that stores data transmitted from the main transmitting buffer in the receiving buffer unit 332. As described above, the streaming service unit 333 also stores the contents received from other transmitting peers at a predetermined storing unit 340 while storing the contents in the receiving buffer in the receiving buffer unit 332. The contents stored in receiving buffers which are not used for providing the streaming service to the user or for storing in the storing unit are deleted.

The transmit error detecting unit 334 determines whether an error occurs or not while receiving the contents from the peers or while providing the streaming service to the user. Also, the transmit error detecting unit 334 checks whether a peer leaves a P2P network or not, or whether a transmit rate or a service speed has been delayed or not. For example, the transmit error detecting unit 334 instantly detects interruption of receiving the contents at a predetermined receiving buffer. In this case, the receiving buffer is changed to other receiving buffer to continuously provide the corresponding streaming service.

The storing process unit 335 stores contents transmitted from each peer at the storing unit 340. the identical content stored in each receiving buffer 332-1 to 332-n in the receiving buffer unit 332 are stored in the storing unit 340. It is preferable that the contents in the receiving buffer are stored in the storing unit 340 by selecting one of the receiving buffers. By storing the received contents in the storing unit 340, corresponding contents can be transmitted to the other peers through the content transmit unit 310 later. Therefore, the P2P based streaming service providing apparatus according to the present invention may function as a transmitting peer and a receiving peer.

As described above, the P2P streaming service providing apparatus and method according to the present invention provides the streaming service by receiving identical contents from a plurality of source peers. Therefore, a peer can provide a stable streaming service although peers frequently leave the P2P network.

It will be apparent to those skilled in the art that various modifications and variations can be made in the present invention. Thus, it is intended that the present invention covers the modifications and variations of this invention provided they come within the scope of the appended claims and their equivalents.

What is claimed is:

1. A method for providing a streaming service in a peer-to-peer (P2P) network comprising a plurality of peers, the method comprising the steps of:
a) at a receiving peer, requesting a plurality of transmitting peers having a content for a streaming service among peers in the P2P network to transmit the content;
b) receiving identical portions of the same content from the plurality of transmitting peers at the same time; and
c) providing a streaming service for the received content from a first transmitting peer among the plurality of transmitting peers to a user.

2. The method of claim 1, wherein the step a) includes the step of searching other peers having the content for the streaming service among peers in the P2P network.

3. The method of claim 1, wherein the step b) includes the step of storing the identical contents received from the plurality of transmitting peers into different receiving buffers.

4. The method of claim 1, wherein the transmitting peer is selected from the plurality of peers transmitting the contents based on a content transmit rate.

5. The method of anyone of claims 1 to 4, wherein a peer having a fastest content transmit rate is decided as the first transmitting peer.

6. The method of claim 1, wherein in the step c), the streaming service of the content is provided to a user in real time at the same time of receiving the content from the first transmitting peer.

7. The method of claim 1, wherein the step c) includes the step of storing the content at a predetermined storing unit at the same time of providing the streaming service of the content received from the first transmitting peer.

8. The method of claim 1, wherein the step c) further includes the step of storing content received from a second transmitting peer among the plurality of transmitting peers in a predetermined storing unit.

9. The method of claim 1, wherein the step c) further includes the step of continuously providing a streaming service of a content using an identical content received from the second transmitting peer among the plurality of transmitting peers when the receiving of the content from the first transmitting peer is interrupted or the transmit rate of the first transmitting peer abruptly decreases, and storing the content in a predetermined storing unit at the same time.

10. The method of claim 1, wherein the step c) further includes the step of continuously providing a streaming service of a content using an identical content received from the second transmitting peer among the plurality of transmitting peers when the receiving of the content from the first transmitting peer is interrupted or the transmit rate of the first transmitting peer is abruptly decreased, receiving an identical content from a third transmitting peer and storing the contents in a predetermined storing unit at the same time.

11. An apparatus for providing a P2P based streaming service through a P2P network comprising a plurality of peers, the apparatus comprising:
a content transmitting unit including a streaming transmitting daemon for performing a program for providing a P2P based streaming service through a P2P network comprising a plurality of peers, and a transmitting buffer for temporally storing contents to transmit to each peer;
a peer searching unit for searching peers that have a content to provide a streaming service among the plurality of peers in the P2P network; and
a content receiving unit includes a streaming receiving daemon for performing a program for receiving a streaming service through the P2P network, a receiving buffer unit having a plurality of receiving buffers for storing identical contents transmitted from different peers through the P2P network, a streaming service unit for providing a streaming service for a content received from one of the different transmitting peers, a transmission error detecting unit for checking at least one of information about whether a peer that transmits a content leaves or not, a content transmit rate and a delay of a streaming service speed, and a storing process unit for storing the contents transmitted from the different peers into a predetermined storing unit.

12. The apparatus of claim 11, wherein one having the fastest content transmit rate among the plurality of different peers is decided as the transmitting peer.

13. The apparatus of claim 11, wherein the content receiving unit continuously provides a streaming service using identical contents received from other peers when the receipt of the content from the transmit peer is interrupted or the transmit rate of the transmitting peer abruptly decreases.

14. The apparatus of claim 11, wherein the content receiving unit provides the streaming service for the content to a user at the same time of receiving the content from the predetermined peer.
